(19) United States
(12) Patent Application Publication
(10) Pub. No.: US 2015/0029721 A1
(43) Pub. Date: Jan. 29, 2015

(54) LED LIGHTING MODULE AND LIGHTING DEVICE USING SAID MODULE

(71) Applicant: KMW INC., Hwaseong (KR)

(72) Inventor: Duk Yong Kim, Youngin (KR)

(73) Assignee: KMW INC., Hwaseong (KR)

(21) Appl. No.: 14/512,213

(22) Filed: Oct. 10, 2014

Related U.S. Application Data
(63) Continuation of application No. PCT/KR2012/002783, filed on Apr. 13, 2012.

(51) Int. Cl. F21V 29/00; F21V 21/30

(52) U.S. Cl. CPC F21V 29/2212; F21V 21/30; F21Y 2101/02
USPC 362/249.02

(57) ABSTRACT

The present invention relates to an LED lighting module and to a lighting device using said module. The LED lighting module comprises: a body frame, the base of which has an accommodation groove; a substrate fixed at an inner installation surface of the accommodation groove of the body frame and having multiple LED packages mounted thereon; multiple heat-dissipating fins arranged on an upper surface and a side surface of the body frame and spaced apart from each other; and a fixing unit protruding from the upper surface of the body fame and having a base surface with a coupling hole for coupling the substrate by means of a bolt. The LED lighting module of the present invention is provided with the protruding fixing unit having an inner surface with the coupling hole for fixing the substrate to the body frame by means of a bolt, and therefore, the overall thickness of the body frame is reduced in order to reduce the weight of the module and improve heat-dissipating characteristics of the module.

### CROSS-REFERENCE TO RELATED APPLICATIONS

This application is a continuation of International Application No. PCT/KR2012/002783 filed on Apr. 13, 2012, the entire disclosure of which is incorporated herein by reference.

### TECHNICAL FIELD

The present invention relates to a LED lighting module and a lighting device using the module, and more particularly, to a LED lighting module with excellent heat-dissipating characteristics and a light weight, and a lighting device using the module.

### RELATED ART

Lately, studies into applying LEDs with less power consumption and a longer life cycle than other light sources to lighting means have been conducted. Since heat generated in LED packages is a factor of reducing the life cycle of the LED packages, research and development for a structure for effectively dissipating heat from LED packages have also been conducted in various ways.

Particularly, a LED street lamp using a plurality of LED packages needs improvement of heat-dissipating characteristics. However, there is limitation in effectively improving heat-dissipating characteristics with a structure in which heat-dissipating fins are installed on the rear side of a PCB substrate with LED packages. Although there was a trial for improving heat-dissipating characteristics by increasing the number and height of heat-dissipating fins, this also showed limitation in improvement of heat-dissipating characteristics since effective air convection could not occur in space between the heat-dissipating fins.

An example of lighting means using LEDs according to prior art is Japanese Registered Utility Model No. 3163002.

The Japanese Registered Utility Model No. 3163002 (hereinafter, simply referred to as prior art 1) disclosures a lighting device with an improved structure in which different shapes of heat-dissipating fins with different heights are alternately arranged on the rear side of a LED installation surface so that air inflows between the heat-dissipating fins with different heights to achieve effective heat-dissipating.

However, the prior art 1 has problems of difficulties in manufacturing it, high manufacturing costs, and poor productivity since it is relatively difficult to fabricate heat-dissipating fins with different heights, and a groove pattern for effective flow of air needs to be formed in the center, upper portions of the heat-dissipating fins.

Also, in the prior art 1, a housing is extruded down from the lateral sides of a LED installation surface that is a surface contacting a substrate on which LED chips are mounted, and some of the heat-dissipating fins are located on the outer sides of the protruded portions. However, since the heat-dissipating fins occupy a significantly small area compared to an area of the heat-dissipating fins located on the rear side of the LED installation surface, they dissipate a very small amount of heat.

The structure in which heat-dissipation occurs mainly through the rear side of the LED installation surface has a low effect of heat-dissipation in consideration of a fact that heat-dissipation efficiency is proportional to the area of heat-dissipating fins within limits.

Furthermore, in the prior art 1, some portions of the frame except for the heat-dissipating fins have different thicknesses. This becomes a factor of reducing the life cycle of some LED chips due to imbalanced heat distribution caused by the differences in thickness of the frame, which leads to reducing the life cycle of the LED lighting device.

Meanwhile, since a LED package has a narrower radiation angle than other lamp-type light sources, the LED package should have a complicated mechanical structure when it is applied to a street lamp in order to meet a minimum radiation angle range required for a street lamp, associated with the height of a street lamp. Such a complicated mechanical structure accompanies design complexity and high manufacturing costs.

Also, since LED street lamps have different illuminance value demands according to regions where they are installed, typical LED street lamps are designed to have appropriate numbers of LED packages in consideration of illuminance value demands. Therefore, it is necessary to newly design and manufacture a lamp when it has a different illuminance value demand.

A plurality of lighting devices according to the prior art 1 can be arranged and combined in parallel to meet an illuminance value demand. However, since the lighting device according to the prior art 1 includes a rotatable rotor, combining a plurality of lighting devices in parallel makes a mechanical configuration for driving rotors independently complicated. Also, rotors extruded outwardly contact a coupling plate to make angle adjustment difficult.

In addition, since a typical street lamp includes a frame in which heat-dissipating fins are arranged on the rear side of an area from which light is emitted, and the frame is installed with a predetermined inclination when the street lamp is installed, moisture remains at angular parts between the rear side of the frame and the heat-dissipating fins.

The moisture may be frozen to become icicles in winter, and when the icicles are unfrozen and fall down, safety accidents may occur. Also, the moisture makes dusts be easily adhered on the frame, and dusts adhered on the frame deteriorate the heat-dissipating characteristics of the street lamp. The deterioration of heat-dissipating characteristics facilitates the life cycle reduction of LEDs due to heat generated from the LEDs.

Also, a substrate on which a plurality of LEDs are mounted is coupled with and installed in the frame, and for bolt coupling of the substrate, the frame is manufactured to have a predetermined thickness or more. Accordingly, due to the thickness of the frame, weight-lightening the LED lighting module is difficult.

### SUMMARY

An aspect of the present invention provides a LED lighting module capable of achieving weight-lightening by reducing a thickness, and a lighting device using the module.

Another aspect of the present disclosure provides a LED lighting module capable of preventing safety accidents and preventing deterioration of heat-dissipating characteristics due to collected dusts by preventing moisture from being collected between a frame and heat-dissipating fins, and a lighting device using the module.

Another aspect of the present disclosure provides a LED lighting module capable of preventing the life cycle reduction of LED packages by improving heat-dissipating characteristics.

Another aspect of the present disclosure provides a lighting device using a LED lighting module capable of flexibly meeting an illuminance value demand of a LED street lamp and arbitrarily adjusting a radiation angle.

In accordance with an aspect of exemplary embodiments of the present invention, there is provided a LED lighting module including: a body frame, a lower portion of which has an accommodation groove; a substrate fixed at an inner installation surface of the accommodation groove of the body frame, and having a plurality of LED packages mounted thereon; a plurality of heat-dissipating fins arranged on an upper surface and lateral surfaces of the body frame, and spaced apart from each other; and a fixing part protruding from the upper surface of the body frame, a lower portion of the fixing part having a coupling hole for coupling the substrate with a bolt.

In accordance with another aspect of exemplary embodiments of the present invention, there is provided a lighting device using a LED lighting module including the LED lighting module of any one of claims 1 to 9, and a pair of support frames configured to fix a plurality of LED lighting modules such that the LED lighting modules fixed at a center portion are at a lower position than the LED lighting modules fixed at edge portions.

The LED lighting module according to the present disclosure can achieve weight lightening and improve heat-dissipating characteristics by providing protrusion type fixing parts including bolt fixing parts for fixing a substrate with bolts to reduce the thickness of a frame.

The LED lighting module according to the present disclosure can prevent water from being collected at borders of the frame and the heat-dissipating fins and prevent dusts from being easily adhered to the frame due to the collected water by designing the rear side of the frame to have a slope such that the center area of the rear side of the frame is higher than the other area, and locating the protrusion type fixing parts closely at the rear sides of the heat-dissipating fins, resulting in preventing safety accidents and deterioration of heat-dissipating characteristics.

The LED lighting module according to the present disclosure can enhance heat-dissipating efficiency by causing LED packages to contact a heat-dissipating panel directly or through a metal PCB with excellent heat conductivity.

The LED lighting module according to the present disclosure can improve heat-dissipating characteristics by providing heat-dissipating fins that extend down along the lateral sides of the LED packages as well as over the rear sides of the LED packages, wherein the areas of the heat-dissipating fins extending down along the lateral sides of the LED packages are equal to the areas of the heat-dissipating fins extending over the rear sides of the LED packages.

Also, the LED lighting module according to the present disclosure can effectively dissipate heat, achieve weight lightening so that it can be easily applied to a product, and facilitate carriage and storage, by reducing the height of the heat-dissipating fins relatively compared to the prior art for effective air convection.

Also, the LED lighting module according to the present disclosure can prevent the life cycle reduction of the LED packages, improve durability, and increase reliability with respect to the life cycle by making the overall thickness of the frame on which the LED packages are mounted uniform to prevent imbalanced heat distribution.

In addition, the lighting device using the LED lighting module according to the present disclosure can be configured to include a plurality of LED lighting modules fixed at their both ends by a support frame so that a street lamp meeting an illuminance value demand can be easily provided by changing the number of modules that are fixed by the support frame.

Also, the lighting device using the LED lighting modules fixed by the support frame can adjust its pointing angle to meet the installation location or interval of the street lamp by adjusting installation angles of the individual LED lighting modules, without changing the design of the street lamp.

Also, the lighting device using the LED lighting module according to the present disclosure can effectively dissipate heat by spacing the plurality of LED lighting modules that are fixed by the support frame so that air convection occurs between the LED lighting modules.

### BRIEF DESCRIPTION OF THE DRAWINGS

FIG. 1 is a perspective view of a LED lighting module according to a preferred embodiment of the present disclosure.

FIG. 2 is a cross-sectional view of the LED lighting module cut along a line A-A of FIG. 1.

FIG. 3 is a perspective view of a LED lighting module according to another embodiment of the present disclosure.

FIG. 4 is a perspective view of the LED lighting module according to another embodiment of the present disclosure.

FIG. 5 is a cross-sectional view of the LED lighting module, cut along a line B-B of FIGS. 3 and 4.

FIG. 6 is a cross-sectional view of a LED lighting module according to another embodiment of the present disclosure.

FIG. 7 is a cross-sectional view of a LED lighting module according to another embodiment of the present disclosure.

FIG. 8 is an exploded perspective view of an LED lighting module according to another embodiment of the present disclosure.

FIG. 9 is a configuration view of a LED lighting module according to another embodiment of the present disclosure.

FIG. 10 is a top view showing an assembled state of an LED lighting device using LED lighting modules according to an embodiment of the present disclosure.

FIG. 11 is a bottom view of the LED lighting device.

FIG. 12 is a front view showing an embodiment of an assembled state of a lighting device using the LED lighting modules according to the present disclosure.

### DETAILED DESCRIPTION

Hereinafter, a LED lighting module according to preferred embodiments of the present disclosure will be described in detail with reference to the appended drawings.

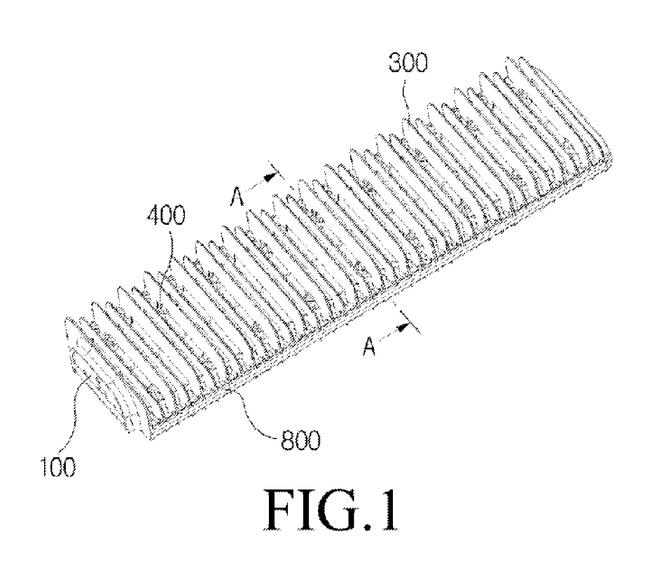

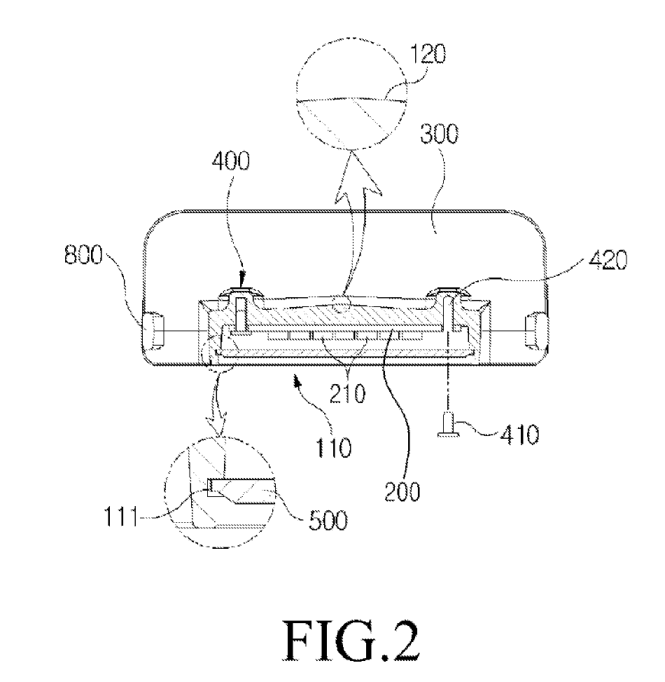

FIG. 1 is a perspective view of a LED lighting module according to a preferred embodiment of the present disclosure, and FIG. 2 is a cross-sectional view of the LED lighting module cut along a line A-A of FIG. 1.

Referring to FIGS. 1 and 2, the LED lighting module according to a preferred embodiment of the present disclosure may include a body frame 100, a lower portion of which has an accommodation groove 110 to provide a heat-dissipating opening and a upper portion of which has a slope 120 whose center area is higher than the other area; a substrate 200 fixed at an inner upper surface of the accommodation groove 110 of the body frame 100, and having a plurality of LED packages 210 mounted thereon; a plurality of heat-dissipating fins 300 arranged on an upper surface of the body frame 100; a fixing part 400 protruding to contact the rear sides of the heat-dissipating fins 300, and having a coupling hole for coupling the substrate 200 with a bolt 410 at the lower portion; a slide cover 500 coupled through slide grooves 111 formed along the lateral area of the accommodation groove 110 of the body frame 100 to prevent foreign materials from being adhered on the substrate 200; and a heat-dissipating panel 800 aligned in a longitudinal direction to connect the heat-dissipating fins 300 to each other along the lateral portion of the body frame 100.

Hereinafter, the configuration and operations of the LED lighting module according to the preferred embodiment of the present disclosure, configured as described above, will be described in more detail.

The body frame 100 may have the accommodation groove 110 at the lower portion, and the slide grooves 111 may be formed along the edge area of the accommodation groove 110. The slide cover 500 may be inserted into the slide grooves 111 from one side, and coupled with the body frame 100 without using coupling means such as bolts, wherein the slide cover 500 may be a transparent cover or a semitransparent cover for diffusion.

By providing the slide grooves 111, it is possible to make the lateral portions of the body frame 100 thin, since no coupling means such as bolts is used and accordingly bolt coupling holes need not to be formed in the lateral portions of the body frame 100.

The thinner the thickness of the body frame 100, the lighter the weight of the body frame 100. Weight lightening of the body frame 100 facilitates an installation work, reduces manufacturing costs, and helps effective heat-dissipating.

Also, the substrate 200 is fixed in the accommodation groove 110 of the body frame 100. The substrate 200 may be a substrate for heat-dissipating, and the plurality of LED packages 210 may be mounted on the substrate 200 such that the light-emitting surfaces of the plurality of LED packages 210 face down.

In order to fix the substrate 200 in the accommodation groove 110 of the body frame 100, the plurality of bolts 410 may be fastened from the substrate 200 to the body frame 100. The fixing parts 400 may protrude from the upper surface of the body frame 100, and the bolts 410 may be inserted into the coupling holes 420 formed in the lower portions of the fixing parts 400 so as to fix the substrate 200.

By providing the fixing parts 400 protruded from the upper surface of the body frame 100, it is possible to insert the bolts 410 for fixing the substrate 200 so that the substrate 200 can be stably coupled with the body frame 100, and to reduce the thickness of the body frame 100, thereby further reducing the weight of the body frame 100. Advantages obtained by weight lightening of the body frame 110 have been described above, and accordingly, further descriptions will be omitted.

Also, the upper surface of the body frame 100 has a structure whose center area has a high height and whose edge areas have a low height, so that water such as rainwater can easily flow down without being collected in the body frame 100. Since water collected in the body frame 100 is frozen to become icicles in winter, safety accidents may occur. Also, water collected in the body frame 100 absorbs dusts, thus deteriorating heat-dissipating characteristics.

In order to prevent water from being collected, it is preferable that any protrusion is not formed on the upper surface of the body frame 100. However, according to the present disclosure, the fixing parts 400 protrude from the upper surface of the body frame 100, and also, the plurality of heat-dissipating fins 300 protrude from the upper surface of the body frame 100, as described above. The fixing parts 400 and the heat-dissipating fins 300 may prevent water from flowing down between the fixing parts 400 and the heat-dissipating fins 300 although the upper surface of the body frame 100 has the slope 120.

In consideration of the fact that there are difficulties in making water flow out due to the heat-dissipating fins 300 and the fixing parts 400, the heat-dissipating fins 300 are designed to have a thicker thickness at the center portions and a thinner thickness at the edge portions, and the fixing parts 400 are designed to contact the rear sides of the heat-dissipating fins 300.

The LED lighting module according to the present disclosure can be used for a street lamp, and the front part of the LED lighting module is installed upward. Accordingly, the fixing parts 400 contacting the rear side of one among the plurality of heat-dissipating fins 300 do not block water between the heat-dissipating fins 300 from flowing out, and the substrate 200 can be firmly coupled with the thin body frame 100. Also, it is possible to prevent water from being collected in the upper surface of the body frame 100 although the fixing parts 400 for fixing the substrate 200 protrude.

Also, the heat-dissipating panels 800 may be provided at the heat-dissipating fins 300 along the lateral portions of the body frame 100, in the longitudinal direction of the body frame 100. The heat-dissipating panels 800 may function to provide a wider heat-dissipating area for the heat-dissipating fins 300 that dissipate heat, while removing imbalanced heat distribution between the heat-dissipating fins 300.

Also, the heat-dissipating panels 800, the heat-dissipating fins 300, and the body frame 100 may be spaced apart from each other so that air convection can occur effectively and heat-dissipating characteristics can be further improved.

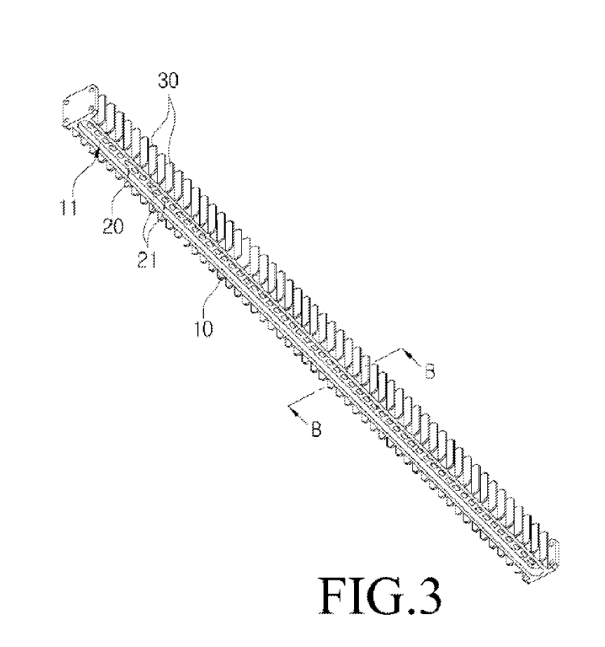

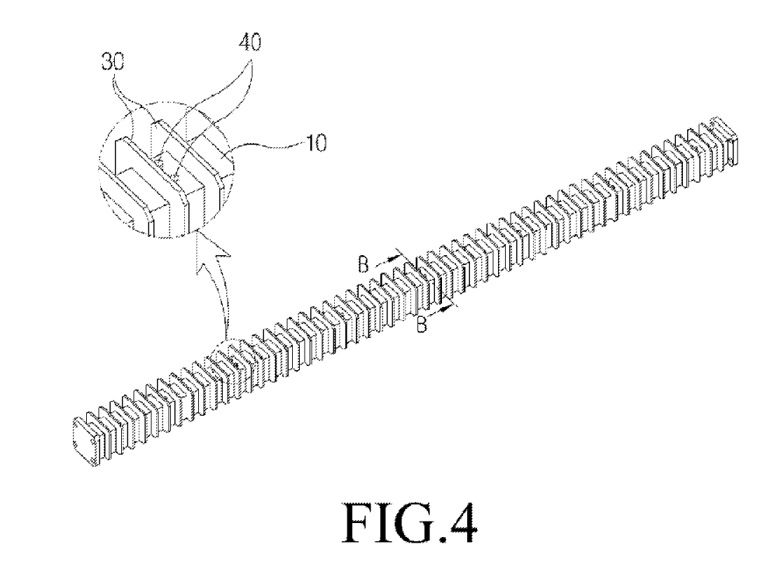

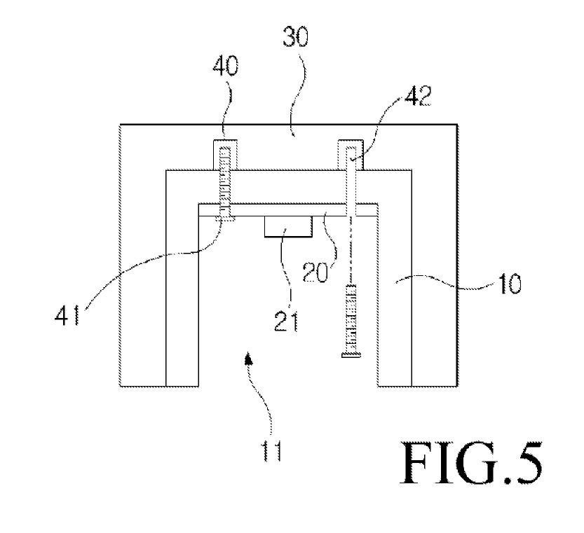

FIG. 3 is a perspective view of a LED lighting module according to another embodiment of the present disclosure as shown from below, FIG. 4 is a perspective view of the LED lighting module according to another embodiment of the present disclosure as shown from above, and FIG. 5 is a cross-sectional view of the LED lighting module, cut along a line A-A of FIGS. 3 and 4.

Referring to FIGS. 3, 4, and 5, the LED lighting module according to another embodiment of the present disclosure may include a body frame 10 having an accommodation groove 11 aligned in a longitudinal direction at the lower portion; a substrate 20 fixed at the inner upper area of the accommodation groove 11 of the body frame 10; a plurality of LED packages 21 mounted on the substrate 20 and emitting light according to a supply voltage supplied through the substrate 20; a plurality of heat-dissipating fins 30 spaced apart from each other, and arranged on the upper and lateral surfaces of the body frame 10; and a plurality of fixing parts 40 protruding from the upper surface of the body frame in order to couple the substrate 20 with the body frame 10 at the inner area of the accommodation groove 11.

The structure described above is obtained by extending the lateral portions of the body frame 10 down to deepen the depth of the accommodation groove 11, compared to the structure described above with reference to FIGS. 1 and 2. Accordingly, the heat-dissipating fins 30 extend along the lateral portions of the body frame 10, thereby further improving heat-dissipating characteristics.

The body frame 10 may be made of a metal material, and may have a hexahedral bar shape. However, the shape of the body frame 10 is not limited to the hexahedral bar shape.

At the lower portion of the body frame 10, the accommodation groove 11 may be formed in the longitudinal direction of the body frame 10. At the bottom area (the upper surface of the groove 11 in the drawing) of the accommodation groove 11, a plurality of fixing parts 40 having a plurality of coupling holes 42 for coupling the substrate 20 with a plurality of bolts 41 at the lower portions may protrude from the upper surface of the body frame 10.

The plurality of LED packages 21 may be mounted on the substrate 20 fixed on the bottom area of the accommodation groove 11, and the LED packages 21 may emit light according to a supply voltage supplied through the substrate 20.

At this time, the LED packages 21 may emit light toward the entrance of the accommodation groove 11. The overall thickness of the body frame 10 may be uniform, which prevents imbalanced heat distribution to prevent the life cycle reduction of some LED packages that are subject to a high temperature.

According to the current embodiment, if the body frame 10 has a cylindrical shape, and the section of the accommodation groove 11 is a quadrangle shape, the body frame 10 may show slight thickness differences at some parts. However, since such differences are extremely small in view of heat transfer, the body frame 10 can be considered to have a substantially uniform thickness. Like the embodiment described above, the upper surface of the body frame 10 may have a slope in order to prevent water from being collected on the upper surface of the body frame 10.

Since the upper surface of the body frame 100 has the slope 120 as shown in FIG. 2, the thickness of the upper portion of the body frame 100 may be different from those of the lateral portions of the body frame 100. That is, in order to form the slope 120 on the upper surface, the upper portion may be machined to be thicker than the lateral portions. Since the upper portion transfers heat emitted from the LED packages 210, effective heat-dissipating can be achieved by increasing the thickness of the upper portion. The slope 120 can be applied to the structures of FIGS. 3, 4, and 5.

When the life cycle of a part of the LED packages 21 ends in the structure described above, the substrate 20 on which all the LED packages 21 are mounted needs to be replaced with a new one because of illuminance, etc., which leads to the life cycle reduction of all the LED packages 21.

The plurality of heat-dissipating fins 30 may be arranged on the body frame 10. Each heat-dissipating fin 30 may be formed as one body, and protrude from the upper and lateral surfaces of the body frame 10 except for the bottom surface of the body frame 10. However, the shape of the heat-dissipating fin 30 is not limited to this.

Particularly, an area of the heat-dissipating fin 30 located on the rear side of the surface of the body frame 10 at which the substrate 20 is fixed may be equal to each of areas of the heat-dissipating fin 30 located on both lateral portions of the body frame 10.

That is, since the heat-dissipating fins 30 have a uniform height and have the same length at the rear side and lateral portions of the body frame 10, heat-dissipating at the lateral portions occurs at the same degree as heat-dissipating at the rear side of the LED packages 21, thereby effectively improving heat-dissipating efficiency.

Since a constant degree of heat-dissipating occurs through the entire area, it is possible to prevent imbalanced heat distribution of the LED lighting module with the bar shape. In the current embodiment, an example in which the body frame 10 has a hexahedral shape is shown so that the upper portion is distinguished from the lateral portions in the drawing. However, the shape of the body frame 10 is not limited to the hexahedral shape. That is, it will be obvious to one of ordinary skill in the art that the above-described features can be applied in the same way to heat-dissipating fins extending to correspond to the outer surface of a body frame which is a cylindrical shape, except for the portion in which the accommodation groove 11 is formed.

Heat generated from the LED packages 21 in this structure may be transferred to the body frame 10 through the substrate 20, and the heat of the body frame 10 may be released into the air through the heat-dissipating fins 30.

Referring again to FIG. 5, the LED packages 21 may be surrounded by the heat-dissipating fins 30. In the prior art, since heat-dissipating fins are provided only above LED packages, or the areas of heat-dissipating fins arranged near the lateral portions of LED packages are relatively small, a major part of heat generated from LED packages may be transferred upward and dissipated. However, in the present disclosure, since the heat-dissipating fins 30 are located above and below the LED packages 21, heat generated from the LED packages 21 is transferred in all directions. Accordingly, a sufficient heat-dissipating area can be ensured although the height of the heat-dissipating fins 30 is lower than in the prior art. By lowering the height of the heat-dissipating fins 30, air can flow to the body frame 10 between the heat-dissipating fins 30.

This structure is designed in consideration that the structure according to the prior art of widening a heat-dissipating area by increasing the height of heat-dissipating fins failed to improve heat-dissipating characteristics according to an increase of the height of the heat-dissipating fins 30 since air does not contact the lower portions of the heat-dissipating fins due to the increased height of the heat-dissipating fins.

Also, since the heat-dissipating fins 30 with a uniform height are used, compared to the structure according to the prior art 1 in which heat-dissipating fins with different heights are alternately arranged, it is possible to easily fabricate the heat-dissipating fins 30, to reduce machining costs to reduce manufacturing costs, and to improve productivity.

Also, by reducing the height of the heat-dissipating fins 30, the weight of the module can be reduced, and due to the weight lightening, advantages can be obtained when the heat-dissipating fins 30 are applied to a lighting device such as a street lamp that needs to consider an influence of wind.

The body frame 10 has a quadrangle frame structure with an opening at the lower portion, and the body frame 10 with the structure is not bent or distorted when the thickness of the body frame 10 is reduced. Accordingly, a LED street lamp using the body frame 10 can have a light weight while having sufficient strength, compared to typical LED street lamps.

Also, since the heat-dissipating fins 30 extend on the lateral surfaces of the body frame 10 as well as the upper surface of the body frame 10, the heat-dissipating fins 30 function as furring bamboos of preventing deformation of the body frame 10 and increasing stiffness of the body frame 10. Fixing parts 40 corresponding to the fixing parts 400 described above with reference to FIGS. 1 and 2 are provided to contact the rear sides of the heat-dissipating fins 30, thereby preventing water from being collected.

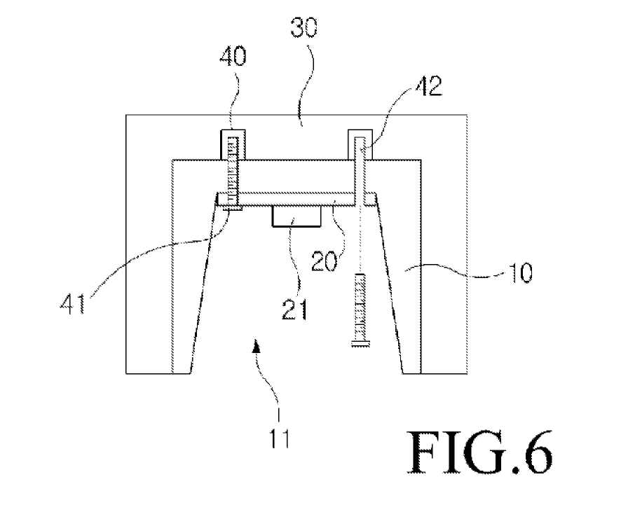

FIG. 6 is a cross-sectional view of a LED lighting module according to another embodiment of the present disclosure.

Referring to FIG. 6, the LED lighting module according to another embodiment of the present disclosure may have a structure in which an accommodation groove 11 has a slope such that the width of the accommodation groove 11 is wider at the entrance area than at the inner area on which a substrate is mounted. This structure can further diffuse light emitted from the LED packages 21, and the lateral surface of the accommodation groove 11 functions as a reflection surface to reflect light.

The structure also enables effective heat-dissipating, has a light weight and hardness, and prevents water collection, like the LED lighting module according to embodiments of the present disclosure as described above.

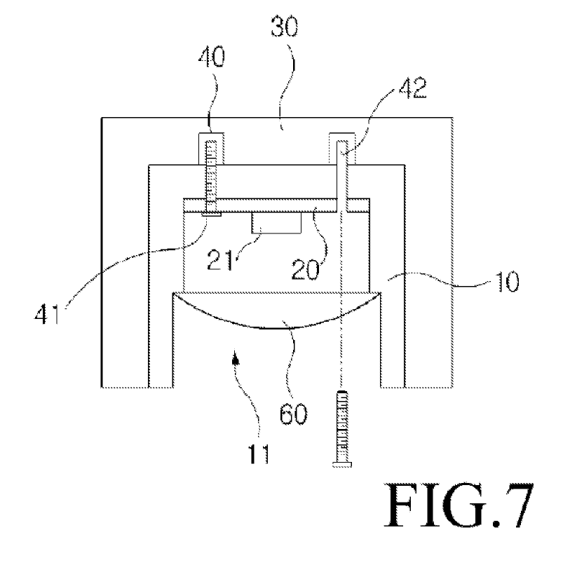

FIG. 7 is a cross-sectional view of a LED lighting module according to another embodiment of the present disclosure.

Referring to FIG. 7, the LED lighting module according to another embodiment of the present disclosure has a structure in which a resting part 12 is formed at a predetermined depth from the entrance of the accommodation groove 11 and a lens 60 is bonded on the resting part 12, compared to the LED lighting module according to an embodiment of the present disclosure as shown in FIG. 3.

The lens 60 functions to refract light emitted from the LED packages 21 at a predetermined angle. By disposing the lens 60, it is possible to easily manufacture a LED lighting module having a pointing angle required for a lighting device, and to process light so that the light can be softly recognized like a surface light source.

Also, by providing the lens 60, the LED packages 21 are sealed from moisture, and accordingly, a cover is not needed

Generally, lightings using LEDs include a cover for protecting the LEDs and forming a surface light source. As shown in the prior art 1 described above, coupling holes for installing such a cover and a resting part are required, and accordingly, the edge portion of a body frame has to be thick in order to install the cover.

In contrast, in the present disclosure, since the resting part 12 for resting the lens 60 is placed in the accommodation groove 11 of the body frame 10 to seal the LED packages 21 without using any cover, the body frame 10 can be manufactured with a uniform thin thickness, which leads to effective heat-dissipating.

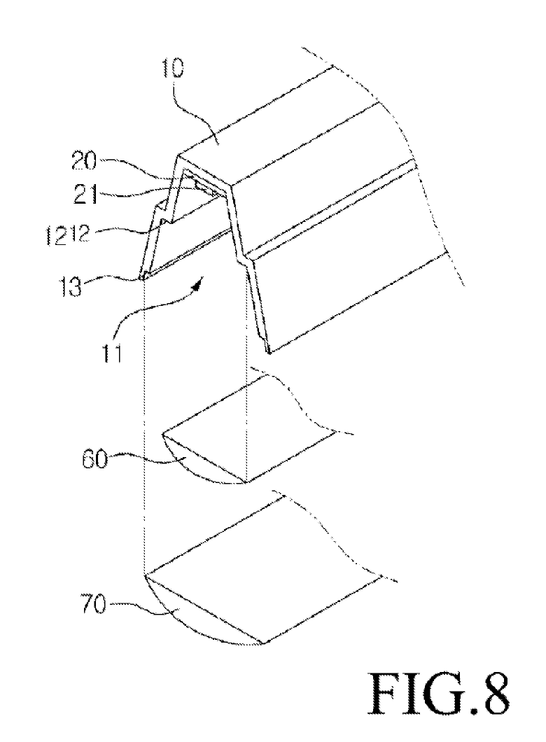

FIG. 8 is an exploded perspective view of an LED lighting module according to another embodiment of the present disclosure.

Referring to FIG. 8, the LED lighting module according to another embodiment of the present disclosure may include a resting part 12 on which a lens 60 can be bonded, the resting part 12 formed by bending a body frame 10, and an outer resting part 13 on which an outer lens 70 can be bonded at the edge portions of the body frame 10.

In the structure shown in FIG. 8, only the body frame 10, the lens 60, and the external lens 70 are shown, and heat-dissipating fins are not shown.

The structure includes the outer resting part 13 at the inside of the body frame 10 and the entrance of the accommodation groove 11 so as to be able to change a radiation angle of the LED packages 21 through the lens 60 and the outer lens 70. The lens 60 and the outer lens 70 have a bar shape that extends along the length of the body frame 10.

By using the lens 60 and the outer lens 70, the LED packages 21 can be further sealed, and since no separate cover is required as described above, heat-dissipating characteristics can be further improved. Detailed descriptions therefor have been described above with reference to FIG. 8, and accordingly, further descriptions will be omitted.

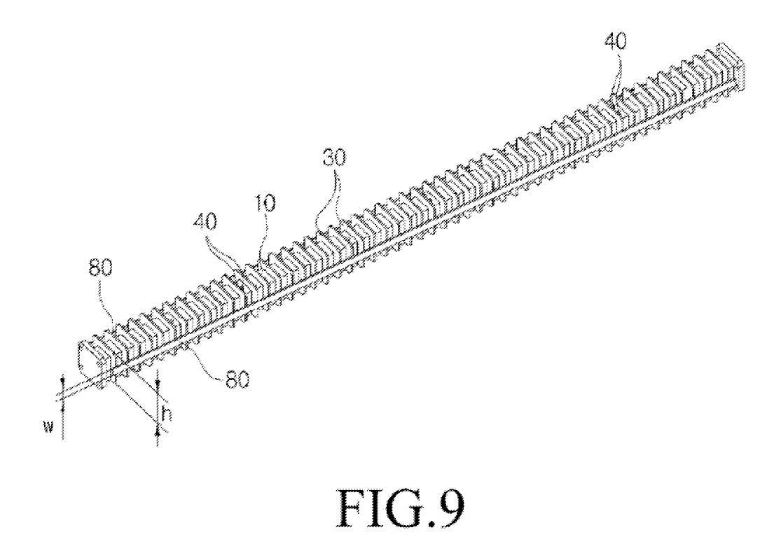

FIG. 9 is a configuration view of a LED lighting module according to another embodiment of the present disclosure.

Referring to FIG. 9, the LED lighting module according to another embodiment of the present disclosure may further include heat-dissipating panels 80 to connect the lateral portions of the heat-dissipating fins 30 to each other along the lateral sides of the body frame 100. Like the heat-dissipating panels 800 described above with reference to FIGS. 1 and 2, the heat-dissipating panels 80 may have a bar shape such as the shape of the body frame 10, and may further improve heat-dissipating characteristics by exchanging heat released from the heat-dissipating fins 30 with external air over a wider area.

Between the heat-dissipating panels 80 and the body frame 10, spaces are formed by the heat-dissipating fins 300, and air is convected into the spaces so that both sides of the heat-dissipating panels 80 contact air to thus dissipate heat.

For effective air convection in the spaces between the heat-dissipating panels 80 and the body frame 10, the width w of the heat-dissipating panels 80 may be narrower than the height h of the heat-dissipating fins 30, as shown in FIG. 9. If the width w of the heat-dissipating panels 80 is wider than or equal to the height h of the heat-dissipating fins 30, air convection cannot easily occur in spaces between the inner surfaces of the heat-dissipating panels 80 and the body frame 10, thereby preventing effective heat-dissipating.

By installing the heat-dissipating panels 80, the heat-dissipating fins 30 become to have balanced heat distribution regardless of their positions. The heat-dissipating panels 80 eliminate imbalanced heat distribution of the heat-dissipating fins 30 by connecting the heat-dissipating fins 30 to each other, so that the entire heat-dissipating fins 30 can be maintained at a constant temperature. Thereby, the life cycle reduction of some LED packages 21 due to imbalanced heat distribution can be prevented.

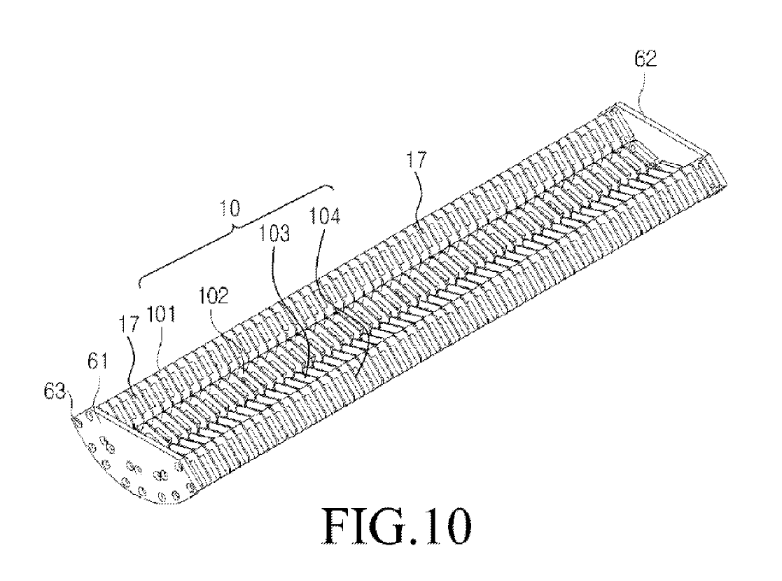

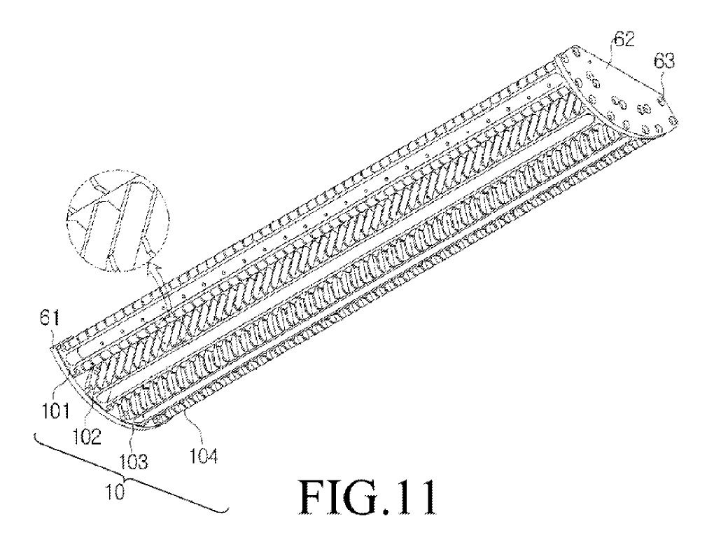

FIG. 10 is a top view showing an assembled state of an LED lighting device using LED lighting modules according to an embodiment of the present disclosure, and FIG. 11 is a bottom view of the LED lighting device.

Referring to FIGS. 10 and 11, the LED lighting device using the LED lighting modules according to an embodiment of the present disclosure may include side protrusions 17 with predetermined areas to couple both ends of the body frame 10 with LED lighting modules 101 to 104 with bolts, wherein the side protrusions 17 are coupled with and fixed at support frames 61 and 62 to support the LED lighting modules 101 to 104 in common.

Preferably, the support frames 61 and 62 may have a circular panel structure such that the LED lighting modules 102 and 103 coupled at the center portion are at a lower position than the LED lighting module 101 and 104 coupled at the edge portions.

In the current embodiment, an example in which the support frames 61 and 62 have a circular panel structure is described, however, it will be obvious to one of ordinary skill in the art that the LED lighting modules 101 to 104 can be arranged in a flat form. Also, it will be inferred by one of ordinary skill in the art that the lighting modules themselves can be designed to form a circular shape.

The LED lighting modules 101 to 104 may change their angles when they are coupled with the support frames 61 and 62 with bolts. By machining bolt coupling holes 63 that are formed in the support frames 61 and 62 after deciding the locations of the bolt coupling holes 63 in consideration of a radiation angle range of a LED street lamp, and coupling the LED lighting modules 101 to 104 at the decided locations, a street lamp meeting a required radiation angle can be provided.

Also, by changing the number of the LED lighting modules 101 to 104, a product meeting an illuminance value demand of a single street lamp can be easily manufactured.

Accordingly, the problem that street lamps with typical LED lighting modules with different radiation angles and different illuminance value demands should be separately designed and manufactured to meet the individual radiation angles and the individual illuminance demands can be overcome.

That is, by fabricating the LED lighting modules 101 to 104 based on a single design, deciding the required number of the LED lighting modules 101 to 104 according to illuminance, changing installation angles of the individual LED lighting modules 101 to 104 according to a radiation angle demand, and then coupling the LED lighting modules 101 to 104, a desired street lamp can be easily provided.

Also, the structure described above allows effective heat-dissipating although a plurality of LED lighting modules according to the present disclosure are coupled. A typical LED street lamp includes a cover to cover the entire LED street lamp. However, in the present disclosure, the LED lighting modules 101 to 104 include separate covers so that effective air convection can occur between the LED lighting modules 101 to 104, thereby improving heat-dissipating characteristics.

As shown in a partial magnified part of FIG. 11, the LED lighting modules 101 to 104 are spaced apart from each other with gaps between them so that effective air convection occurs through the gaps. Accordingly, since air convection can occur effectively between the heat-dissipating fins 30 (see FIG. 9) of the individual LED lighting modules 101 to 104 although the plurality of LED lighting modules 101 to 104 are used, heat-dissipating characteristics can be further improved.

As such, since heat-dissipating occurs effectively, the life cycle reduction of the LED packages 21 can be prevented.

All the embodiments of the LED lighting module described above with reference to FIGS. 1 to 8 can be applied to the structure shown in FIGS. 10 and 11.

The LED lighting modules 101 to 104 described above with reference to FIGS. 10 and 11 may be coupled at a radiation angle decided when the LED lighting modules 101 to 104 are installed. However, the installation angles of the LED lighting modules 101 to 104 can be arbitrarily adjusted even after they are installed, so that a radiation angle of a LED street lamp can be changed as necessary.

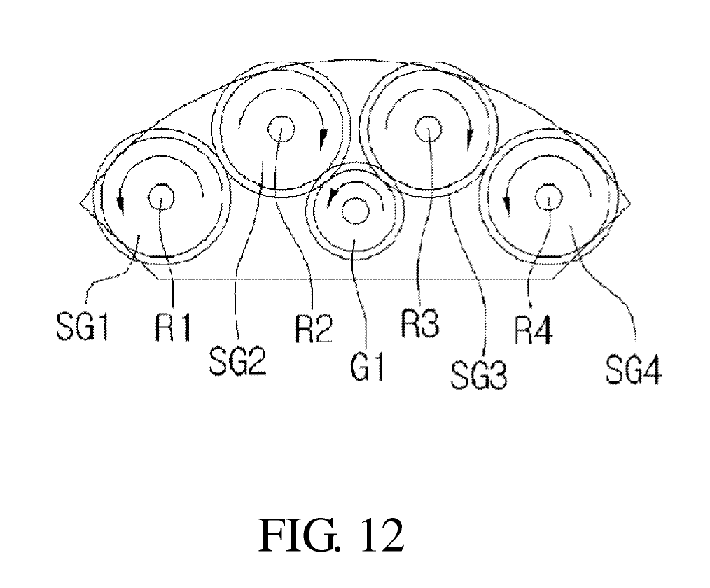

FIG. 12 is a front view showing an embodiment of an assembled state of a lighting device using the LED lighting modules according to the present disclosure.

Referring to FIG. 12, the plurality of LED lighting modules may be coupled with the support frame 61 through rotary shafts R1 to R4, and the rotary shafts R1 to R4 may be respectively coupled with inverted gears SG1 to SG4 from the outside of the support frame 61. The rotary shafts R1 to R4 may rotate by a motor (not shown), and when a driving gear G1 interlocked with the inverted gears SG1 to SG4 rotates at a predetermined angle, the rotation may be transferred to the LED lighting modules to thus adjust a radiation angle.

The above description relates to a simple example of adjusting the angles of the LED lighting modules at the same time. However, it will be easily understood to one of ordinary skill in the art that the angles of the LED lighting modules can be adjusted independently by driving the LED lighting modules individually as necessary.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

According to the present disclosure, by providing a LED lighting module with a light weight, it is possible to facilitate construction, to prevent moisture from being collected in the LED lighting module to prevent safety accidents in winter, and to prevent deterioration of heat-dissipating characteristics due to collected dusts.

What is claimed is:

1. A LED lighting module comprising:
a body frame, a lower portion of which has an accommodation groove;
a substrate fixed at an inner installation surface of the accommodation groove of the body frame, and having a plurality of LED packages mounted thereon;
a plurality of heat-dissipating fins arranged on an upper surface and lateral surfaces of the body frame, and spaced apart from each other; and
a fixing part protruding from the upper surface of the body frame, a lower portion of the fixing part having a coupling hole for coupling the substrate with a bolt.

2. The LED lighting module of claim 1, wherein a upper surface of the body frame has a slope whose center area in a longitudinal direction is higher than edge areas.

3. The LED lighting module of claim 1, wherein the fixing part protrudes from a upper surface of the body frame at locations that contact rear sides of the heat-dissipating fins.

4. The LED lighting module of claim 1, wherein the heat-dissipating fins have a thicker thickness at center portions and a thinner thickness at edge portions.

5. The LED lighting module of claim 1, wherein the accommodation groove of the body frame has a slope at a lateral area such that the width of the accommodation groove is wider at an entrance area than at an inner area.

6. The LED lighting module of claim 1, further comprising a heat-dissipating panel configured to connect the heat-dissipating fins to each other along a lateral portion of the body frame.

7. The LED lighting module of claim 1, wherein a slide groove is formed in a lateral area of the accommodation groove of the body frame, further comprising a slide cover coupled through the slide groove.

8. The LED lighting module of claim 1, wherein the overall thickness of the body frame is uniform.

9. The LED lighting module of claim 2, wherein a upper portion of the body frame is thicker than both lateral portions of the body frame.

10. A lighting device using a LED lighting module, comprising the LED lighting module of claim 1, and a pair of support frames configured to fix a plurality of LED lighting modules such that the LED lighting modules fixed at a center portion are at a lower position than the LED lighting modules fixed at edge portions.

11. The lighting device of claim 10, wherein angles of the plurality of LED lighting modules whose both ends are fixed on the pair of support frames are respectively adjusted to meet a radiation angle range of a street lamp.

12. The lighting device of claim 10, wherein the plurality of LED lighting modules are coupled with the pair of support frames through a plurality of rotary shafts, and radiation angles of the plurality of LED lighting modules are changed by rotation.

13. The lighting device of claim 10, wherein both ends of the plurality of LED lighting modules are fixed on the pair of support frames in such a manner that the plurality of LED lighting modules are spaced apart from each other.
